(19) United States
(12) Patent Application Publication
(10) Pub. No.: US 2019/0311470 A1
(43) Pub. Date: Oct. 10, 2019

(54) APPAREL PRODUCTION MONITORING SYSTEM USING IMAGE RECOGNITION

(71) Applicant: ONS Communications, Seoul (KR)

(72) Inventors: Kang-Kwon Lee, Seoul (KR); Kyung-Wan Chu, Yongin-si (KR); Yoo-Seok Kang, Seoul (KR); Sang-Wook Cho, Yongin-si (KR)

(21) Appl. No.: 16/296,763

(22) Filed: Mar. 8, 2019

(30) Foreign Application Priority Data
Apr. 10, 2018 (KR) 10-2018-0041811

(51) Int. Cl. G06T 7/00; G06N 20/00; G06T 7/62; G06T 7/13

(52) U.S. Cl. CPC G06T 7/001; G06N 20/00; G06T 7/62; H04N 7/181; G06T 2207/20081; G06T 2207/30124; G06T 7/13

(57) ABSTRACT

Provided is an apparel production monitoring system using image recognition, including: a first camera module that takes an image of apparel products; and a monitoring device that analyzes the image of the apparel products to grasp the number and sizes of the apparel products, receives a transmission image of the apparel products, and compares and analyzes it with a previously learned transmission image to detect a defect of the apparel products.

### TECHNICAL FIELD

The present disclosure relates to an apparel production monitoring system and device using image recognition.

### BACKGROUND

The apparel industry is a labor-intensive industry as well as a technology-intensive industry that needs a high level of technology. A lot of labor and a high level of technology are needed particularly for a process of manufacturing apparel products and a process of producing apparel products including final inspection and packing.

In general, a number of workers have been put to a production line of apparel products to conduct total inspection including classification of the apparel products, grasping the number of the apparel products, defect inspection of the apparel products, and the like. In such situations, it has been difficult to quickly supplement the absence of a worker with another worker and it has taken a lot of time to transfer the work process to a new worker. Further, since every worker has different work efficiency, it has been difficult for a manager to readily check the flow of apparel production and the status of production. Furthermore, if the workers cannot detect a defective product by mistake during total inspection and the defective product is delivered to a consumer, it may cause damage and deterioration in reliability.

In order to solve this problem, there have been attempts to apply a machine vision system that performs an analysis function based on image information acquired by a camera to an apparel production system. However, the conventional machine vision system is very dependent on images acquired by the camera and thus is sensitive to its surrounding environment. Therefore, it has been difficult to accurately recognize apparel objects and the performance of the system has not been uniform due to such variables.

The background technology of the present disclosure is disclosed in Korean Patent Laid-open Publication No. 2018-0004898 (published on Jan. 15, 2018).

### SUMMARY

In view of the foregoing, the present disclosure provides an apparel production monitoring system and device that makes it possible to automate total inspection of apparel products, monitor production status of apparel products for each process, and can provide uniform performance in spite of changes in its surrounding environment.

However, problems to be solved by the present disclosure are not limited to the above-described problems. There may be other problems to be solved by the present disclosure.

According to an aspect of the present disclosure, there is provided an apparel production monitoring system using image recognition, including: a first camera module that takes an image of apparel products; and a monitoring device that analyzes the image of the apparel products to grasp the number and sizes of the apparel products, receives a transmission image of the apparel products, and compares and analyzes it with a previously learned transmission image to detect a defect of the apparel products.

According to an embodiment of the present disclosure, the monitoring device may compute pixel characteristics of a background image acquired before the first camera module takes the image of the apparel products, set a first region of interest in the background image, set a second region of interest in the image of the apparel products, compute a difference in pixel characteristics between an image of an apparel product in the second region of interest and a background image in the first region of interest, perform binarization to a result of the computed difference and thus recognize an object of the apparel product from the binarized image.

According to an embodiment of the present disclosure, the monitoring device may update pixel characteristics of the background image based on pixel characteristics of a background included in the image of the apparel products.

According to an embodiment of the present disclosure, the apparel production monitoring system using image recognition may further include a second camera module configured to take an image of the side of multiple overlapping apparel products, and the monitoring device may acquire a first thickness of an apparel product from a previously learned image of the apparel products, acquire a second thickness of the multiple overlapping apparel products from the image of the side of the multiple overlapping apparel products, and grasp the number of the multiple overlapping apparel products from the first thickness and the second thickness.

According to an embodiment of the present disclosure, the monitoring device may acquire a pattern of the apparel product from the image of the apparel products and compare and analyze it with a previously learned pattern in an apparel material image to grasp a material of the apparel product.

According to an embodiment of the present disclosure, the monitoring device may extract a contour image of the apparel product from the image of the apparel products and compare and analyze it with a previously learned contour image for each kind of apparel product to grasp the kind of the apparel product.

According to an embodiment of the present disclosure, the monitoring device may detect edges from the image of the apparel product and set the edges as feature points, acquire shapes of the feature points, and calculate a maximum vertical length and a maximum horizontal length of the apparel product from the feature points to grasp the size of the apparel product from the maximum vertical length and the maximum horizontal length.

According to an embodiment of the present disclosure, the defect of the apparel products may include a logo error, a thread, color bleeding, a needle, and a defective design pattern.

According to an embodiment of the present disclosure, the monitoring device may previously learn a transmission image for each defect of the apparel products and store a learning result file for each defect of the apparel products and may load the learning result file at the time of defect inspection of the apparel products, and compare and analyze it with the transmission image of the apparel products to grasp the kind of defect of the apparel products and the location of the defect in the apparel products.

According to another aspect of the present disclosure, there is provided an apparel production monitoring device using image recognition, including: an image acquisition unit that receives an image of apparel products taken by a camera module and receives a transmission image of the apparel products; a product count unit that counts the number of the apparel products based on the image of the apparel products; a product sensing unit that senses information of the apparel products based on the image of the apparel products; and a defect detection unit that detects a defect of the apparel products by comparing and analyzing the transmission image of the apparel products with a previously learned transmission image.

According to an embodiment of the present disclosure, the image of the apparel products may include an image of the side of multiple overlapping apparel products, and the product count unit may acquire a first thickness of an apparel product from a previously learned image of the apparel products, acquire a second thickness of the multiple overlapping apparel products from the image of the side of the multiple overlapping apparel products, and grasp the number of the multiple overlapping apparel products from the first thickness and the second thickness.

The product sensing unit may acquire pixel characteristics and a pattern of the apparel product from the image of the apparel products and compare and analyze then with pixel characteristics and a previously learned pattern in an apparel material image to grasp a material of the apparel product.

The product sensing unit may extract a contour image of the apparel product from the image of the apparel products and compare and analyze it with a previously learned contour image for each kind of apparel product to grasp the kind of the apparel product.

The product sensing unit may detect edges from the image of the apparel product and set the edges as feature points, acquire shapes of the feature points, and calculate a maximum vertical length and a maximum horizontal length of the apparel product from the feature points to grasp the size of the apparel product from previously learned shapes of feature points, the maximum vertical length and the maximum horizontal length.

The defect of the apparel products may include a logo error, a thread, color bleeding, a needle, and a defective design pattern.

The defect detection unit may load a learning result file of a transmission image for each defect of the apparel products, which have been previously learned and stored, at the time of defect inspection of the apparel products, and compare and analyze it with the transmission image of the apparel products to grasp the kind of defect of the apparel products and the location of the defect in the apparel products.

The above-described aspects are provided by way of illustration only and should not be construed as liming the present disclosure. Besides the above-described exemplary embodiments, there may be additional exemplary embodiments described in the accompanying drawings and the detailed description.

According to the above-described aspects of the present disclosure, the camera module takes an image of apparel products on a production line and the monitoring device receives and analyzes the image of the apparel products, and, thus, the process of total inspection of the apparel products is performed automatically. Therefore, total inspection of apparel products can be automated.

Further, according to the above-described aspects of the present disclosure, total inspection of apparel products, such as classification of apparel products and defect inspection of apparel products, which has been performed by workers can be automated. Thus, labor saving and the reduction of labor costs can be achieved. Also, the reduction of work hours and the improvement of work quality can be achieved.

Furthermore, according to the above-described aspects of the present disclosure, a monitoring result can be provided in detail through a display device. Therefore, it is possible to readily check the current status for each production process of apparel products and also possible to rapidly recognize the occurrence of a problem and deal with the problem.

Moreover, according to the above-described aspects of the present disclosure, an object recognition algorithm is used to update and reflect characteristics of a background image except apparel products. Thus, even if there is any change in the surrounding environment such as a failure of a light or changes of day and night, the same performance can be provided.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a configuration view of an apparel production monitoring system according to an embodiment of the present disclosure.

FIG. 2 is an example diagram illustrating a process for recognizing an object of an apparel product by an apparel production monitoring system according to an embodiment of the present disclosure.

FIG. 3 is an example diagram illustrating a process for grasping the number of overlapping apparel products by the apparel production monitoring system according to an embodiment of the present disclosure.

FIG. 4A is an example diagram illustrating a process for grasping the color of an apparel product by the apparel production monitoring system according to an embodiment of the present disclosure.

FIG. 4B is an example diagram illustrating a process for grasping the material of an apparel product by the apparel production monitoring system according to an embodiment of the present disclosure.

FIG. 5 is an example diagram illustrating a process for grasping the kind of apparel product by the apparel production monitoring system according to an embodiment of the present disclosure.

FIG. 6 is an example diagram illustrating a process for grasping the size of an apparel product by the apparel production monitoring system according to an embodiment of the present disclosure.

FIG. 7A is an example diagram illustrating a stored result of a learning result file for each defect of an apparel product according to an embodiment of the present disclosure.

FIG. 7B is an example diagram illustrating a process of grasping the kind of defect of an apparel product and the location of the defect in the apparel product by the apparel production monitoring system according to an embodiment of the present disclosure.

FIG. 8A through FIG. 8E are example diagrams illustrating configurations of a monitoring screen for apparel products according to an embodiment of the present disclosure.

FIG. 9 is a configuration view of an apparel production monitoring device according to an embodiment of the present disclosure.

### DETAILED DESCRIPTION

Hereafter, examples will be described in detail with reference to the accompanying drawings so that the present disclosure may be readily implemented by those skilled in the art. However, it is to be noted that the present disclosure is not limited to the examples but can be embodied in various other ways. In the drawings, parts irrelevant to the description are omitted for the simplicity of explanation, and like reference numerals denote like parts through the whole document.

Throughout this document, the term “connected to” may be used to designate a connection or coupling of one element to another element and includes both an element being “directly connected” another element and an element being “electronically connected” to another element via another element.

Through the whole document, the terms “on”, “above”, “on an upper end”, “below”, “under”, and “on a lower end” that are used to designate a position of one element with respect to another element include both a case that the one element is adjacent to the other element and a case that any other element exists between these two elements.

Through the whole document, the term “comprises or includes” and/or “comprising or including” used in the document means that one or more other components, steps, operation and/or existence or addition of elements are not excluded in addition to the described components, steps, operation and/or elements unless context dictates otherwise.

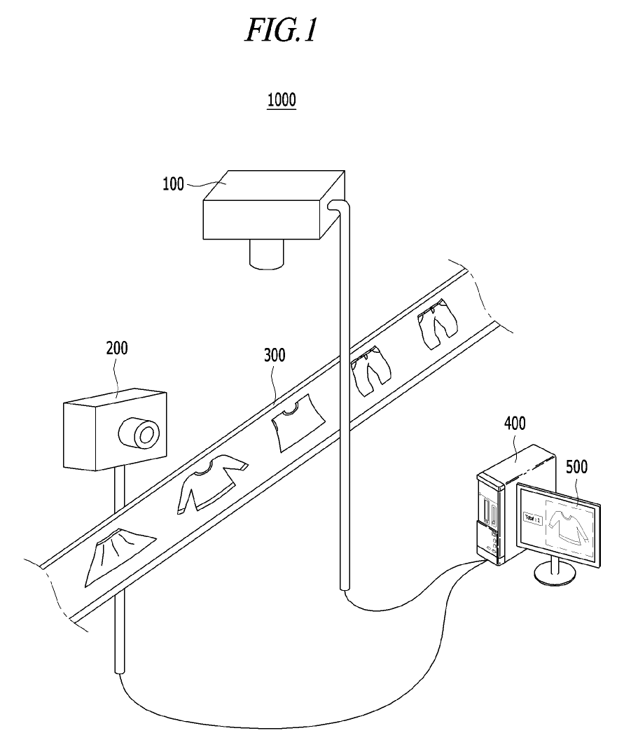

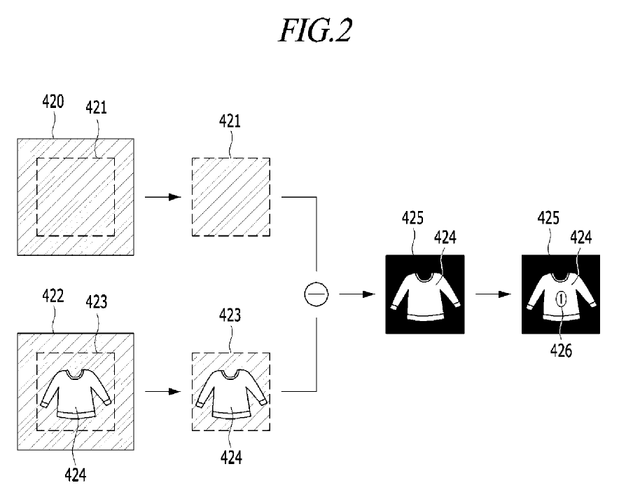

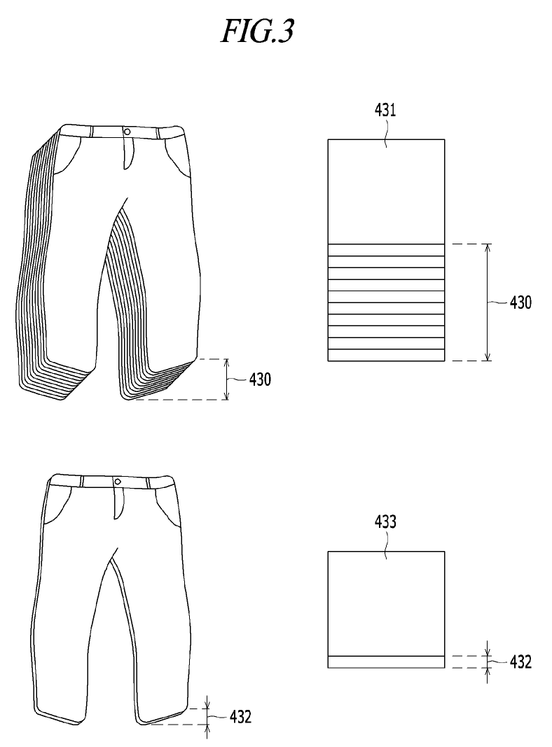

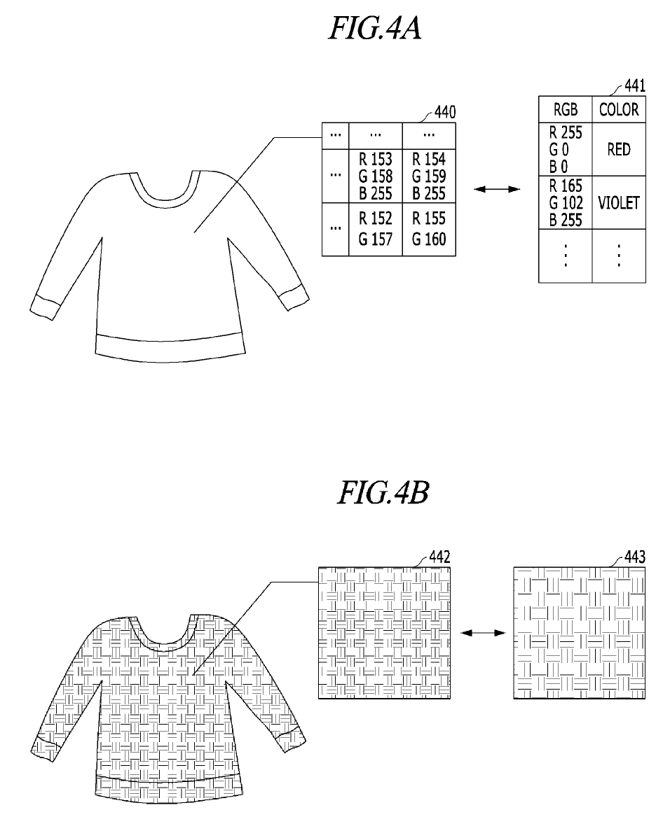

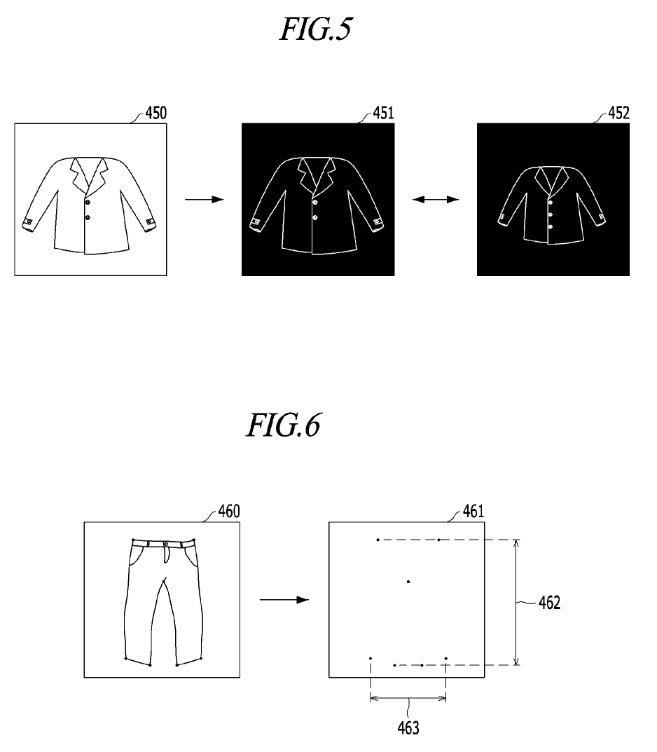

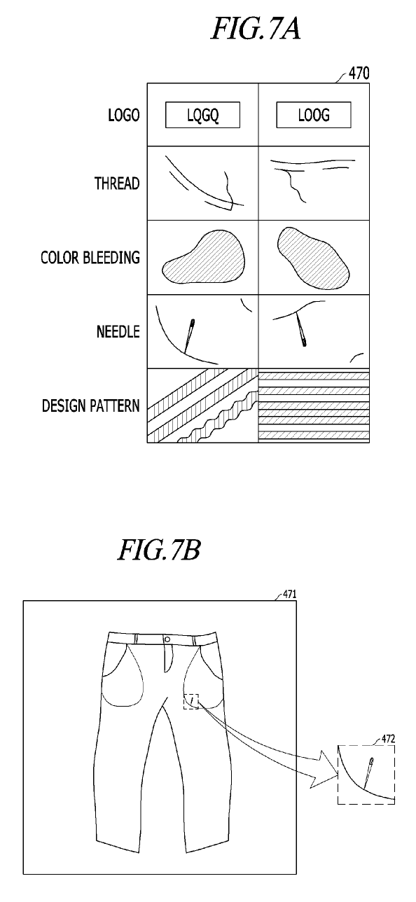

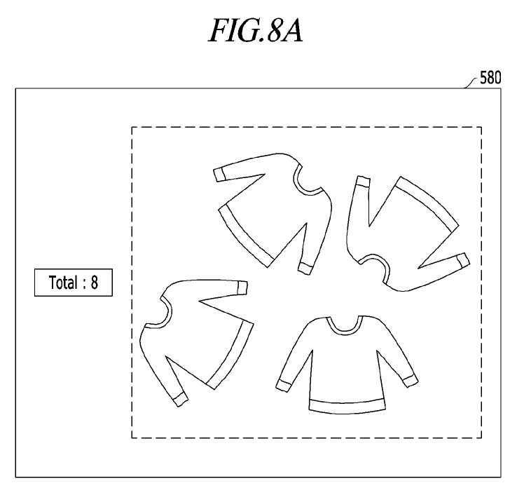

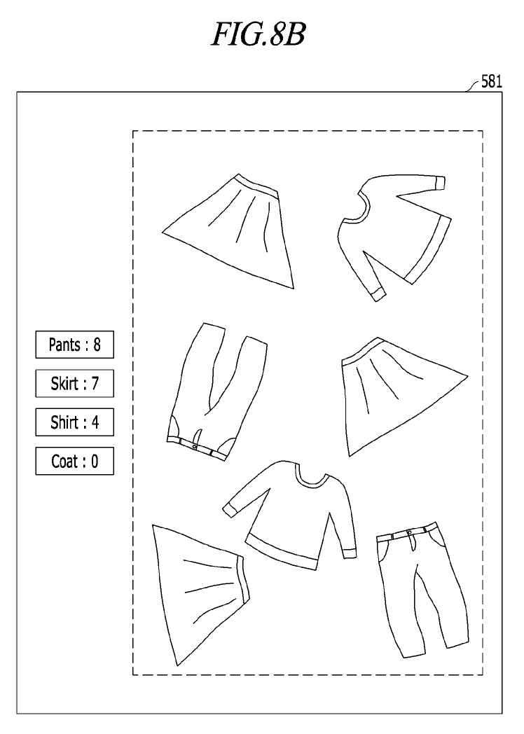

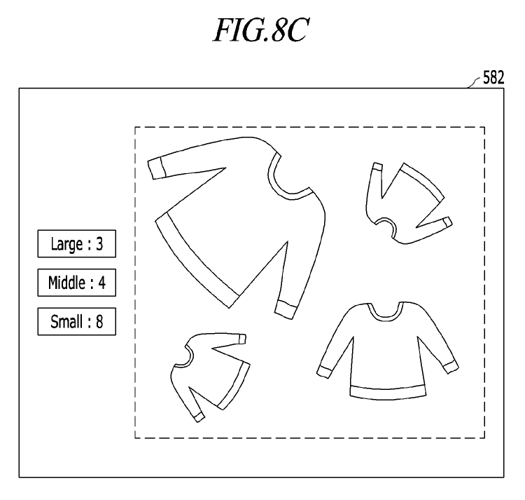

FIG. 1 is a configuration view of an apparel production monitoring system according to an embodiment of the present disclosure. Further, FIG. 2 is an example diagram illustrating a process for recognizing an object of an apparel product by an apparel production monitoring system according to an embodiment of the present disclosure. Furthermore, FIG. 3 is an example diagram illustrating a process for grasping the number of overlapping apparel products by the apparel production monitoring system according to an embodiment of the present disclosure. Moreover, FIG. 4A is an example diagram illustrating a process for grasping the color of an apparel product by the apparel production monitoring system according to an embodiment of the present disclosure. Besides, FIG. 4B is an example diagram illustrating a process for grasping the material of an apparel product by the apparel production monitoring system according to an embodiment of the present disclosure. Further, FIG. 5 is an example diagram illustrating a process for grasping the kind of apparel product by the apparel production monitoring system according to an embodiment of the present disclosure. Furthermore, FIG. 6 is an example diagram illustrating a process for grasping the size of an apparel product by the apparel production monitoring system according to an embodiment of the present disclosure. Moreover, FIG. 7A is an example diagram illustrating a stored result of a learning result file for each defect of an apparel product according to an embodiment of the present disclosure, and FIG. 7B is an example diagram illustrating a process of grasping the kind of defect of an apparel product and the location of the defect in the apparel product by the apparel production monitoring system according to an embodiment of the present disclosure.

Referring to FIG. 1, an apparel production monitoring system 1000 using image recognition according to an embodiment of the present disclosure may include a first camera module 100, a second camera module 200, a monitoring device 400, and a display device 500.

The first camera module 100 may take an image of apparel products. Further, the second camera module 200 may take an image of the side of multiple overlapping apparel products. The first camera module 100 and the second camera module 200 may include various kinds of cameras capable of taking an image of apparel products and may include additional components such as a lens, a light, and the like. As illustrated in FIG. 1, according to an embodiment of the present disclosure, the first camera module 100 may be located above a moving line 300 on which apparel products are placed and moved in order to take a planar image of the apparel products and the second camera module 200 may be located on the side of the moving line 300 in order to take an image of the side of the apparel products. For example, the moving line 300 may include a conveyer belt.

Further, the monitoring device 400 according to an embodiment of the present disclosure may analyze the image of the apparel products to grasp the number, kinds, materials, colors, and sizes of the apparel products. Furthermore, the monitoring device 400 may receive a transmission image of the apparel products and compare and analyze it with a previously learned transmission image to detect a defect of the apparel products.

Moreover, the display device 500 according to an embodiment of the present disclosure may display the number, kinds, and sizes of the apparel products and the detected defect of the apparel products as grasped by the monitoring device 400.

The first camera module 100, the second camera module 200, the monitoring device 400, and the display device 500 of the apparel production monitoring system 1000 according to an embodiment of the present disclosure can be connected to each other through a network. The network may include both wired and wireless networks and may include various kinds of networks such as a LAN (Local Area Network), a Wireless LAN (Wireless Local Area Network), a WAN (Wide Area Network), a PAN (Personal Area Network), a Wi-Fi Network, a Bluetooth network, a wifi network, an NFC (Near Field Communication) network, 3G, LTE (Long Term Evolution), a 5G network, a WIMAX (World Interoperability for Microwave Access) network, and the like.

Further, FIG. 1 illustrates that the first camera module 100, the second camera module 200, the monitoring device 400, and the display device 500 are implemented by separate modules or devices, respectively. However, at least some of the first camera module 100, the second camera module 200, the monitoring device 400, and the display device 500 may be implemented by one integrated module or device. For example, the apparel production monitoring system 1000 according to an embodiment of the present disclosure may be implemented as a smartphone, a smart pad, a tablet PC, a smart TV, or the like.

Further, a memory device to be described hereafter may be a device to temporarily or permanently store data in a computer. For example, the memory device may include a magnetic disc, an optical disc, a ROM, a RAM, non-volatile memory, tape, and the like. Furthermore, the memory device may be implemented by a module or device separate from the monitoring device 400 or may be implemented by one integrated module or device.

The monitoring device 400 according to an embodiment of the present disclosure may recognize an object 424 of an apparel product from an image 422 of the apparel product. Specifically, referring to FIG. 2, the monitoring device 400 may receive, from the first camera module 100, a background image 420 acquired before the first camera module 100 takes the image 422 of the apparel product. The background image 420 acquired before the image 422 of the apparel product is taken may be an image including the moving line 300 and its surrounding environment in a state where no apparel product is present on the moving line 300. Further, the monitoring device 400 may compute pixel characteristics of the acquired background image 420. For example, the pixel characteristics may include the number of pixels included in the image, an RGB value in each pixel, a brightness value, a saturation value, a hue value, and the like. The monitoring device 400 may receive, in real time or periodically, the background image 420 acquired before the first camera module 100 takes the image 422 of the apparel product, compute pixel characteristics, and compute and store a cumulative average. Further, the monitoring device 400 may set and extract a first region of interest 421 in the background image 420 acquired before the image 422 of the apparel product is taken. The first region of interest 421 refers to a partial or whole region of the background image 420 acquired before the image 422 of the apparel product is taken, and the size of the first region of interest 421 can be adjusted.

Further, the monitoring device 400 may receive the image 422 of the apparel product from the first camera module 100. The image 422 of the apparel product may be an image including the apparel product placed and moved on the moving line 300 and its surrounding environment at that time. Furthermore, the monitoring device 400 may set and extract a second region of interest 423 in the image 422 of the apparel product. An image of the second region of interest 423 may include an object image and a background image of the apparel product. The second region of interest 423 refers to a partial or whole region of the image 422 of the apparel product, and the size of the second region of interest 423 can be adjusted. For example, the sizes and shapes of the first region of interest 421 and the second region of interest 423 can be set by a user, and the first region of interest 421 and the second region of interest 423 are identical to each other in size and shape.

Further, the monitoring device 400 may compute pixel characteristics of the image 422 of the apparel product or the image of the second region of interest 423. For example, the pixel characteristics may include the number of pixels included in the image, an RGB value in each pixel, a brightness value, a saturation value, a hue value, and the like.

Furthermore, the monitoring device 400 may perform preprocessing to the image of the first region of interest 421 and the image of the second region of interest 423. The preprocessing may include removing noise and dividing boundary to improve the performance of object recognition.

Moreover, the monitoring device 400 may compute a difference between the image of the first region of interest 421 and the image of the second region of interest 423. The computation may include computing a difference between a cumulative average of pixel characteristics of the image of the first region of interest 421 and pixel characteristics of the image of the second region of interest 423. Besides, the monitoring device 400 may perform binarization to a result of the computed difference to acquire a background-removed image 425 of the apparel product. For example, as shown in FIG. 2, the object 424 of the apparel product may be displayed in white and the background may be displayed in black. Further, the monitoring device 400 may perform removing noise from the background-removed image 425 of the apparel product to acquire a clear image from which noise is removed.

Furthermore, the monitoring device 400 may perform labeling 426 to the background-removed image 425 of the apparel product to recognize the object 424 of the apparel product. The labeling 426 may be performed by labeling a number on the object 424 of the apparel product in the background-removed image 425 of the apparel product. Moreover, the labeling 426 may be recognized within the monitoring device 400 to be invisible to the user. FIG. 2 illustrates that the object 424 of only one apparel product is recognized, but the monitoring device 400 can also recognize objects of multiple apparel products.

The monitoring device 400 according to an embodiment of the present disclosure may receive, in real time or periodically, the image 422 of the apparel product taken by the first camera module 100. Further, the monitoring device 400 may update pixel characteristics of the background image based on pixel characteristics of a background included in the image 422 of the apparel product which is received in real time or periodically. The monitoring device 400 may compute pixel characteristics of the background except the object 424 of the apparel product included in the image 422 of the apparel product and compute a cumulative average for the background except the object 424 to update the pixel characteristics of the background image 420 acquired before the image 422 of the apparel product is taken.

The monitoring device 400 may update a cumulative average of the pixel characteristics of the background image based on the following Equation 1.

dst(x,y)<−(1−alpha)*src(x,y)+alpha*src(x,y) if mask(x,y)!=0 [Equation 1]

Herein, “dst(x,y)” is a cumulative average of the background image, “alpha*src(x,y)” is the product of the weight and a pixel characteristic of the background in a current image, and “(1−alpha)*src(x,y)” may mean the product of the weight and a pixel characteristic of the background in a previous image.

Therefore, it is possible to overcome the disadvantage of object recognition based on image analysis that is sensitive to surrounding environment and greatly affected by the surrounding environment and also possible to continuously update changes in surrounding environment other than an object. Thus, it is possible to improve the performance of real-time object recognition.

The monitoring device 400 according to an embodiment of the present disclosure may grasp the number of multiple overlapping apparel products. For example, referring to FIG. 3, the monitoring device 400 may receive an image 431 of the side of the overlapping apparel products from the second camera module 200. Further, the monitoring device 400 may acquire a second thickness 430 of the overlapping apparel products from the image 431 of the side of the overlapping apparel products. For example, the monitoring device 400 may compute the second thickness 430 by image analysis.

Further, the monitoring device 400 according to an embodiment of the present disclosure can retrieve a previously stored image 433 of the side of an apparel product. The previously stored image 433 of the side of an apparel product may be received from the memory device. Furthermore, the monitoring device 400 may acquire a first thickness 432 of an apparel product from the previously stored image 433 of the side of an apparel product.

The monitoring device 400 may grasp the number of the multiple overlapping apparel products from the second thickness 430 and the first thickness 432. For example, the number of the multiple apparel products can be grasped from the second thickness 430 and the first thickness 432 by dividing the second thickness 430 by the first thickness 432.

Further, the monitoring device 400 according to an embodiment of the present disclosure may receive an X-ray image of the multiple overlapping apparel products from an X-ray imaging device connected to the monitoring device 400 and grasp the number of the multiple apparel products by recognizing lines of the respective overlapping apparel products from the X-ray image of the multiple overlapping apparel products. Furthermore, according to an embodiment of the present disclosure, the monitoring device 400 may receive the image 431 of the side of the overlapping apparel products from the second camera module 200 and perform a labeling process for object recognition to the image 431 of the side of the apparel products to grasp the number of the multiple apparel products by labeling to the lines of the respective overlapping apparel products.

The monitoring device 400 according to an embodiment of the present disclosure may grasp the colors of the apparel product from the image 422 of the apparel product. For example, referring to FIG. 4A, the monitoring device 400 may acquire pixel characteristics 440 of the apparel product from the image 422 of the apparel product. For example, the monitoring device 400 may decompose the image of the apparel product into pixel units and analyze the image. Specifically, as shown in FIG. 4A, the monitoring device 400 may acquire the pixel characteristics 440 of each pixel in the image of the apparel product. For example, the monitoring device 400 may extract an RGB value among the pixel characteristics to acquire the colors of the apparel product.

Further, the monitoring device 400 may retrieve previously learned pixel characteristics 441 for each color. The pixel characteristics 441 for each color may include a RGB value for each color. For example, the R, G, B value for black may be 0, 0, 0 and the R, G, B value for white may be 255, 255, 255. Further, the pixel characteristics 441 for each color may be composed of pixel characteristics for each of one or more colors. Furthermore, the previously learned pixel characteristics 441 for each color may be previously stored in the memory device by the user. Moreover, the monitoring device 400 may receive the previously learned pixel characteristics 441 for each color from the memory device. Besides, the monitoring device 400 may compare and analyze the pixel characteristics 440 of the apparel product with the previously learned pixel characteristics 441 for each color to grasp the colors of the apparel product. For example, when an average of RGB values of respective pixels among the pixel characteristics 400 of the apparel product is compared with the previously learned pixel characteristics 441 for each color, if a similarity is equal to or more than a predetermined level, it is possible to grasp the colors of the apparel product. The pixel characteristics 440 of the apparel product may include one or more pixels.

Further, referring to FIG. 4B, the monitoring device 400 may acquire a pattern 442 of the apparel product from the image 422 of the apparel product. Furthermore, the monitoring device 400 may retrieve a previously learned pattern 443 of an apparel material image. The previously learned pattern 443 of the apparel material image may be previously stored in the memory device by the user. Moreover, the monitoring device 400 may receive the previously learned pattern 443 of the apparel material image from the memory device. Besides, the monitoring device 400 may compare and analyze the pattern 442 of the apparel product with the previously learned pattern 443 of the apparel material image to grasp the material of the apparel product. For example, comparison and analysis of the patterns may be performed using image comparison algorithms such as histogram-based comparison, template matching, feature matching, and the like.

The monitoring device 400 according to an embodiment of the present disclosure may grasp the kind of the apparel product. For example, referring to FIG. 5, the monitoring device 400 may extract a contour image 451 of an apparel product from an image 450 of the apparel product from which the contour is to be extracted. Further, the monitoring device 400 may retrieve a previously learned contour image 452 for each kind of apparel product. The previously learned contour image 452 for each kind of apparel product may be previously stored in the memory device by the user. Furthermore, the monitoring device 400 may receive the previously learned contour image 452 for each kind of apparel product from the memory device. Moreover, the monitoring device may compare and analyze the contour image 451 of the apparel product with the previously learned contour image 452 for each kind of apparel product to grasp the kind of the apparel product.

For example, the monitoring device 400 may perform image matching between the contour image 451 of the apparel product and the image 452 for each kind of apparel product to analyze a similarity to the image 452 for each kind of apparel product. Further, the monitoring device may grasp which kind of apparel product the image 452 for each kind of apparel product showing the highest similarity based on the analyzed similarity belongs to. For reference, image matching between the contour image 451 of the apparel product and the contour image 452 for each kind of apparel product may be performed using image comparison algorithms such as histogram-based comparison, template matching, feature matching, and the like. The kind of the apparel product may include, for example, pants, skirt, shirt, coat, socks, and the like.

The monitoring device 400 according to an embodiment of the present disclosure may grasp the size of the apparel product. For example, referring to FIG. 6, the monitoring device 400 may detect edges from the image 422 of the apparel product. Further, the monitoring device 400 may acquire an image 460 including the edges marked with points. Furthermore, the monitoring device 400 may acquire a feature point image 461 from the image 460 including the edges marked with points. The feature point image 461 refers to an image of only points extracted from the image 460 including the edges marked with points.

Further, the monitoring device 400 may grasp the kind of the apparel product from the feature point image 461. For example, the monitoring device 400 may grasp the kind of the apparel product from a previously learned feature point image for each product. The previously learned feature point image for each product may be obtained by detecting edges of the apparel product, marking the detected edges with points and then extracting only the points as described above. The previously learned feature point image for each product may be previously stored in the memory device. Further, the monitoring device 400 may receive the previously learned feature point image for each product from the memory device. Furthermore, the monitoring device 400 may perform image matching between the previously learned feature point image for each product and the extracted feature point image 461 to grasp which kind of apparel product the feature point image 461 belongs to.

Moreover, the monitoring device 400 may acquire a maximum vertical length 462 and a maximum horizontal length 463 of the apparel product from the feature point image 461. For example, the maximum vertical length 462 may be acquired by drawing parallel lines including an uppermost point and a lowermost point in the feature point image 461 and measuring a distance between the parallel lines. Further, the maximum horizontal length 463 may be acquired by drawing parallel lines including a rightmost point and a leftmost point in the feature point image 461 and measuring a distance between the parallel lines. Herein, the uppermost point, the lowermost point, the rightmost point, and the leftmost point may include multiple points. In this case, the parallel lines need to be drawn including all the multiple points. For reference, the above-described upper, lower, right, and left are directions on the drawing.

Further, the monitoring device 400 may grasp the size of the apparel product from the maximum vertical length 462 and the maximum horizontal length 463. For example, when the maximum vertical length 462 and the maximum horizontal length 463 are within a predetermined range, the monitoring device 400 may determine the apparel product as having a predetermined corresponding size. The monitoring device 400 may previously store data of a maximum vertical length and a maximum horizontal length for determining the size for each kind of apparel product. Herein, the predetermined range and the corresponding size may be added or changed freely by a manager.

Furthermore, in order to grasp the size of the apparel product, the kind of the apparel product needs to be determined in advance or simultaneously. Therefore, as described above, the monitoring device 400 may determine the kind of the apparel product and grasp the size for each kind of apparel product simultaneously by acquiring the contour image from the image of the apparel product.

The monitoring device 400 according to an embodiment of the present disclosure may grasp the kind of defect of the apparel product and the location of the defect in the apparel product. For example, referring to FIG. 7A and FIG. 7B, the monitoring device 400 may store a learning result file 470 for each defect of the apparel product. The learning result file 470 for each defect may be stored in the memory device. FIG. 7A illustrates that the learning result file 470 for each defect is stored in the form of image, but the learning result file 470 for each defect may be stored in various forms of data. For example, the defect of the apparel product may include a logo error, a thread, color bleeding, a needle, and a defective design pattern. According to an embodiment of the present disclosure, the monitoring device 400 may analyze and define a feature of an image for each defect and determine the kind of the defect. For example, when a character is included in the image and a difference from a standard character image is greater than a predetermined level according to analysis of the image, the monitoring device 400 may determine the image as having a logo error. Further, when a boundary of color region is smaller than a predetermined reference value according to analysis of the image, the monitoring device 400 may determine the image as having color bleeding. Furthermore, when an object has a width smaller than a predetermined first reference value and a length greater than a predetermined second reference value, the monitoring device 400 may determine the object as a sharp object such as a needle. For example, the first reference value and the second reference value may be set with reference to the width and length of a minimum-sized needle.

Further, the monitoring device 400 may receive a transmission image 471 of the apparel product. For example, the transmission image 471 of the apparel product may be an X-ray image and may be received from an image device or memory device connected to the monitoring device 400. Furthermore, the monitoring device 400 may load the learning result file 470 for each defect to detect a defect from the transmission image 471 of the apparel product. Moreover, the monitoring device 400 may check whether there is a portion 472 suspected as having a defect of the apparel product in the transmission image 471 of the apparel product based on the learning result file 470 for each defect. For example, the monitoring device 400 may compare and analyze the images to check whether a partial or whole region of the transmission image of the apparel product matches with some files within the learning result file 470 for each defect. The comparison and analysis may be conducted using various image analysis algorithms. Further, the monitoring device 400 may mark the portion 472 suspected as having a defect on the transmission image 471 of the apparel product.

The monitoring device 400 according to an embodiment of the present disclosure may simultaneously perform the processes described above with reference to FIG. 2 through FIG. 7B. For example, the monitoring device 400 may grasp the number for each kind of apparel product, the number for each material, and the number for each size, or may grasp the number for each kind and each size of apparel product.

Therefore, the apparel production monitoring system 1000 according to an embodiment of the present disclosure automatically performs the above-described total inspection process including counting the number of apparel products, grasping the colors, materials, kinds, and sizes of the apparel products, and detecting defects. Thus, total inspection of apparel products can be automated. Since total inspection can be automated, workers do not have to perform total inspection of apparel products any longer. Therefore, labor saving and the reduction of labor costs can be achieved. Also, the reduction of work hours and the improvement of work quality can be achieved.

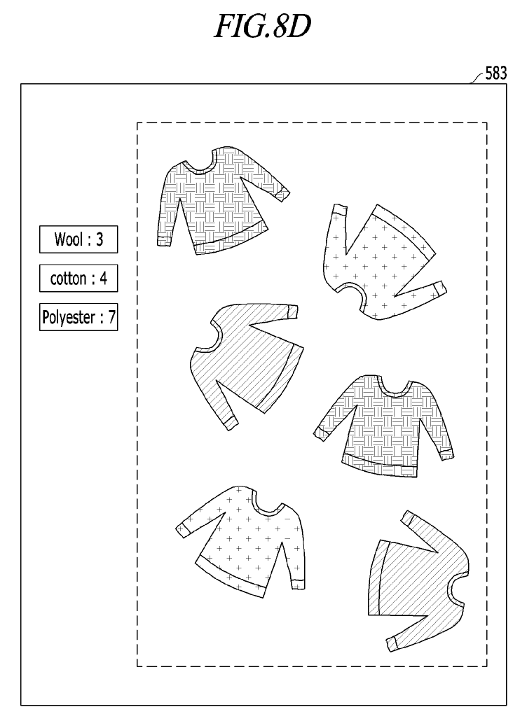

FIG. 8A through FIG. 8E are example diagrams illustrating configurations of a monitoring screen for apparel products according to an embodiment of the present disclosure.

Referring to FIG. 8A, the monitoring device 400 may output a first monitoring screen 580 through the display device 500. The first monitoring screen 580 for apparel product according to an embodiment of the present disclosure may count the number of apparel products moving along the moving line 300 and display the number.

Further, referring to FIG. 8B, the monitoring device 400 may output a second monitoring screen 581 through the display device 500. The second monitoring screen 581 for apparel product according to an embodiment of the present disclosure may display the kinds of apparel products moving along the moving line 300 and the number of apparel products for each kind. Furthermore, referring to FIG. 8C, the monitoring device 400 may output a third monitoring screen 582 through the display device 500. The third monitoring screen 582 for apparel product according to an embodiment of the present disclosure may display the sizes of apparel products moving along the moving line 300 and the number of apparel products for each size. Although not illustrated in the drawing, the monitoring device 400 may grasp the size for each kind of apparel product and display the number of apparel products for each size. Moreover, referring to FIG. 8D, the monitoring device 400 may output a fourth monitoring screen 583 through the display device 500. The fourth monitoring screen 583 for apparel product according to an embodiment of the present disclosure may display the materials of apparel products moving along the moving line 300 and the number of apparel products for each material.

Further, referring to FIG. 8E, the monitoring device 400 may output a fifth monitoring screen 584 through the display device 500. The fifth monitoring screen 584 for apparel product according to an embodiment of the present disclosure may display the location of a defect on the transmission image 471 of the apparel product and display the kind of a defect of each apparel product and the frequency of defects. Furthermore, the monitoring device 400 may display a cumulative frequency of defects for each kind of defect of all the apparel products.

Moreover, if a defect is detected from the apparel product, the fifth monitoring screen 584 may inform the user that the defect has been detected from the apparel product in a recognizable form. For example, as shown in FIG. 8E, the fifth monitoring screen 584 may inform the user that the defect has been detected from the apparel product by turning on an alert light. The alert light can be modified into various recognizable forms such as voice, vibration, and the like. Although FIG. 8E illustrates that the apparel production monitoring system 1000 includes the alert light, the apparel production monitoring system 1000 may not include the above-described recognizable forms as needed by the user.

Further, the monitoring device 400 may perform the above-described process of grasping the kinds, sizes and materials of apparel products simultaneously and display the counted number of the apparel products for each kind, size, or material on the monitoring screen output through the display device 500.

The monitoring screen output by the monitoring device 400 through the display device 500 can be configured freely by the manager. For example, the monitoring screen may be configured with only the number for each kind of apparel product and the number for each size of apparel product. The monitoring screen may be configured in other ways as needed by the manager. The monitoring screen output by the monitoring device 400 according to an embodiment of the present disclosure through the display device 500 can provide the above-described total inspection process of apparel products in detail. Therefore, it is possible to readily check the current status for each production process of apparel products and also possible to rapidly recognize the occurrence of a problem and deal with the problem.

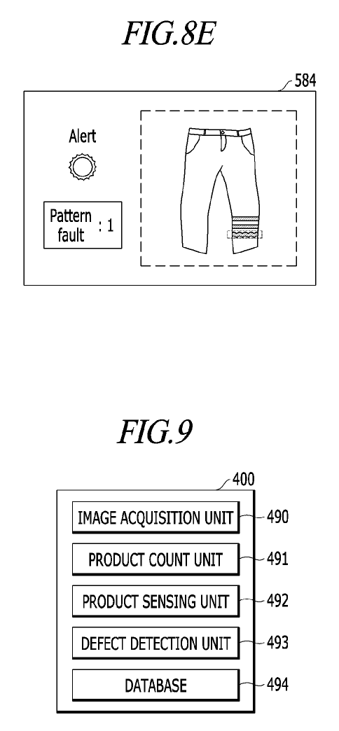

FIG. 9 is a configuration view of an apparel production monitoring device according to an embodiment of the present disclosure.

Referring to FIG. 9, the monitoring device 400 according to an embodiment of the present disclosure may include an image acquisition unit 490, a product count unit 491, a product sensing unit 492, a defect detection unit 493, and a database 494.

According to an embodiment of the present disclosure, the image acquisition unit 490 may receive images of an apparel product taken by the first camera module 100 and the second camera module 200. Further, the image acquisition unit 490 may receive the transmission image 471 of the apparel product.

According to an embodiment of the present disclosure, the product count unit 491 may count the number of apparel products based on an image 420 of the apparel products. For example, referring to FIG. 2, the product count unit 491 may perform labeling 426 to the background-removed image 425 of the apparel products. Herein, the product count unit 491 may count the number of the apparel products by counting the number of labelings 426. FIG. 2 illustrates that the labeling 426 is performed only to the object 424 of one apparel product, but the product count unit 491 can perform the labeling 426 to objects of multiple apparel products.

Further, the product count unit 491 according to an embodiment of the present disclosure may grasp the number of multiple overlapping apparel products. For example, referring to FIG. 3, the product count unit 491 may receive the image 431 of the side of the overlapping apparel products from the image acquisition unit 490. Further, the product count unit 491 may acquire the second thickness 430 of the overlapping apparel products from the image 431 of the side of the overlapping apparel products.

Further, the product count unit 491 according to an embodiment of the present disclosure can retrieve the previously stored image 433 of the side of an apparel product. The previously stored image 433 of the side of an apparel product may be received from the memory device. Furthermore, the product count unit 491 may acquire the first thickness 432 of the apparel product from the previously stored image 433 of the side of an apparel product.

The product count unit 491 may grasp the number of the multiple apparel products from the second thickness 430 and the first thickness 432. For example, the number of the multiple apparel products can be grasped from the second thickness 430 and the first thickness 432 by dividing the second thickness 430 by the first thickness 432.

According to an embodiment of the present disclosure, the product sensing unit 492 may sense information of the apparel product based on the image 420 of the apparel product. Further, the product sensing unit 492 according to an embodiment of the present disclosure may grasp the colors of the apparel product from the image 422 of the apparel product. For example, referring to FIG. 4A, the product sensing unit 492 may acquire pixel characteristics 440 of the apparel product from the image 422 of the apparel product. For example, the product sensing unit 492 may decompose the image of the apparel product into pixel units and analyze the image. Specifically, as shown in FIG. 4A, the product sensing unit 492 may acquire pixel characteristics of each pixel. Further, the product sensing unit 492 may extract an RGB value among the pixel characteristics to acquire the colors of the apparel product.

Further, the product sensing unit 492 may retrieve the previously learned pixel characteristics 441 for each color. The pixel characteristics 441 for each color may include a RGB value for each color. For example, the R, G, B value for black may be 0, 0, 0 and the R, G, B value for white may be 255, 255, 255. Further, the pixel characteristics 441 for each color may be composed of pixel characteristics for each of one or more colors. Furthermore, the previously learned pixel characteristics 441 for each color may be previously stored in the memory device by the user. Moreover, the product sensing unit 492 may receive the previously learned pixel characteristics 441 for each color from the memory device. Besides, the product sensing unit 492 may compare and analyze the pixel characteristics 440 of the apparel product with the previously learned pixel characteristics 441 for each color to grasp the colors of the apparel product. For example, when an average of RGB values among the pixel characteristics 440 of the apparel product is compared with the previously learned pixel characteristics 441 for each color, if a similarity is close to or more than a predetermined level, it is possible to grasp the colors of the apparel product. The pixel characteristics 440 of the apparel product may include one or more pixels.

Further, referring to FIG. 4B, the product sensing unit 492 may acquire the pattern 442 of the apparel product from the image 422 of the apparel product. Furthermore, the product sensing unit 492 may retrieve the previously learned pattern 443 of an apparel material image. The previously learned pattern 443 of the apparel material image may be previously stored in the memory device by the user. Moreover, the product sensing unit 492 may receive the previously learned pattern 443 of the apparel material image from the memory device. Besides, the product sensing unit 492 may compare and analyze the pattern 442 of the apparel product with the previously learned pattern 443 of the apparel material image to grasp the material of the apparel product. For example, comparison and analysis of the patterns may be performed using image comparison algorithms such as histogram-based comparison, template matching, feature matching, and the like.

The product sensing unit 492 according to an embodiment of the present disclosure may grasp the kind of the apparel product. For example, referring to FIG. 5, the product sensing unit 492 may extract the contour image 451 of an apparel product from the image 450 of the apparel product from which the contour is to be extracted. Further, the product sensing unit 492 may retrieve the previously learned contour image 452 for each kind of apparel product. The previously learned contour image 452 for each kind of apparel product may be previously stored in the memory device by the user. Furthermore, the product sensing unit 492 may receive the previously learned contour image 452 for each kind of apparel product from the memory device. Moreover, the product sensing unit 492 may compare and analyze the contour image 451 of the apparel product with the previously learned contour image 452 for each kind of apparel product to grasp the kind of the apparel product.

For example, the product sensing unit 492 may perform image matching between the contour image 451 of the apparel product and the image 452 for each kind of apparel product to analyze a similarity to the image 452 for each kind of apparel product. Further, the product sensing unit 492 may grasp which kind of apparel product the image 452 for each kind of apparel product showing the highest similarity based on the analyzed similarity belongs to. For reference, image matching between the contour image 451 of the apparel product and the contour image 452 for each kind of apparel product may be performed using image comparison algorithms such as histogram-based comparison, template matching, feature matching, and the like. The kind of the apparel product may include, for example, pants, skirt, shirt, coat, socks, and the like.

The product sensing unit 492 according to an embodiment of the present disclosure may grasp the size of the apparel product. For example, referring to FIG. 6, the product sensing unit 492 may detect edges from the image 422 of the apparel product. Further, the product sensing unit 492 may acquire the image 460 including the edges marked with points. Furthermore, the product sensing unit 492 may acquire the feature point image 461 from the image 460 including the edges marked with points. The feature point image 461 refers to an image of only points extracted from the image 460 including the edges marked with points.

Further, the product sensing unit 492 may grasp the kind of the apparel product from the feature point image 461. For example, the product sensing unit 492 may grasp the kind of the apparel product from a previously learned feature point image for each product. The previously learned feature point image for each product may be obtained by detecting edges of the apparel product, marking the detected edges with points and then extracting only the points as described above. The previously learned feature point image for each product may be previously stored in the memory device. Further, the product sensing unit 492 may receive the previously learned feature point image for each product from the memory device. Furthermore, the product sensing unit 492 may perform image matching between the previously learned feature point image for each product and the feature point image 461 to grasp which kind of apparel product the feature point image 461 belongs to.

Moreover, the product sensing unit 492 may acquire the maximum vertical length 462 and the maximum horizontal length 463 of the apparel product from the feature point image 461. For example, the maximum vertical length 462 may be acquired by drawing parallel lines including an uppermost point and a lowermost point in the feature point image 461 and measuring a distance between the parallel lines. Further, the maximum horizontal length 463 may be acquired by drawing parallel lines including a rightmost point and a leftmost point in the feature point image 461 and measuring a distance between the parallel lines. Herein, the uppermost point, the lowermost point, the rightmost point, and the leftmost point may include multiple points. In this case, the parallel lines need to be drawn including all the multiple points. For reference, the above-described upper, lower, right, and left are directions on the drawing.

Further, the product sensing unit 492 may grasp the size of the apparel product from the maximum vertical length 462 and the maximum horizontal length 463. For example, when the maximum vertical length 462 and the maximum horizontal length 463 are within a predetermined range, the product sensing unit 492 may determine the apparel product as having a predetermined corresponding size. The product sensing unit 492 may previously store data of a maximum vertical length and a maximum horizontal length for determining the size for each kind of apparel product. Herein, the predetermined range and the corresponding size may be added or changed freely by the manager.

Furthermore, in order to grasp the size of the apparel product, the kind of the apparel product needs to be determined in advance or simultaneously. Therefore, as described above, the product sensing unit 492 may determine the kind of the apparel product and grasp the size for each kind of apparel product simultaneously by acquiring the contour image from the image of the apparel product.

The defect detection unit 493 according to an embodiment of the present disclosure may grasp the kind of defect of the apparel product and the location of the defect in the apparel product. For example, referring to FIG. 7A and FIG. 7B, the defect detection unit 493 may store the learning result file 470 for each defect of the apparel product. The learning result file 470 for each defect may be stored in the memory device. FIG. 7A illustrates that the learning result file 470 for each defect is stored in the form of image, but the learning result file 470 for each defect may be stored in various forms of data. For example, the defect of the apparel product may include a logo error, a thread, color bleeding, a needle, and a defective design pattern. According to an embodiment of the present disclosure, the defect detection unit 493 may analyze and define a feature of an image for each defect and determine the kind of the defect. For example, when a character is included in the image and a difference from a standard character image is greater than a predetermined level according to analysis of the image, the defect detection unit 493 may determine the image as having a logo error. Further, when a boundary of color region is smaller than a predetermined reference value according to analysis of the image, the defect detection unit 493 may determine the image as having color bleeding. Furthermore, when an object has a width smaller than a predetermined first reference value and a length greater than a predetermined second reference value, the defect detection unit 493 may determine the object as a sharp object such as a needle. For example, the first reference value and the second reference value may be set with reference to the width and length of a minimum-sized needle.

Further, the defect detection unit 493 may receive the transmission image 471 of the apparel product. For example, the transmission image 471 of the apparel product may be an X-ray image and may be received from an image device or memory device connected to the defect detection unit 493. Furthermore, the defect detection unit 493 may load the learning result file 470 for each defect to detect a defect from the transmission image 471 of the apparel product. Moreover, the defect detection unit 493 may check whether there is the portion 472 suspected as having a defect of the apparel product in the transmission image 471 of the apparel product based on the learning result file 470 for each defect. For example, the defect detection unit 493 may compare and analyze the images to check whether a partial or whole region of the transmission image of the apparel product matches with some files within the learning result file 470 for each defect. The comparison and analysis may be conducted using various image analysis algorithms. Further, the defect detection unit 493 may mark the portion 472 suspected as having a defect on the transmission image 471 of the apparel product.

Furthermore, the database 494 may store the images taken by the first camera module 100 and the second camera module 200. Moreover, the database 494 may store arbitrary data. Further, the database 494 may be a device configured to temporarily or permanently retain data in a computer. For example, the database 494 may include magnetic disc, optical disc, ROM, RAM, nonvolatile memory, tape, and the like. Further, the database 494 may be implemented by a module or device separate from the monitoring device 400 or may be implemented by one integrated module or device.

A driving method of the apparel production monitoring system and device according to an embodiment of the present disclosure may be implemented in an executable program command form by various computer means and be recorded in a computer-readable storage medium. The computer-readable storage medium may include a program command, a data file, and a data structure individually or a combination thereof. The program command recorded in the computer-readable storage medium may be specially designed or configured for the present disclosure or may be known to those skilled in a computer software field to be used. Examples of the computer-readable storage medium include magnetic media such as hard disk, floppy disk, or magnetic tape, optical media such as CD-ROM or DVD, magneto-optical media such as floptical disk, and a hardware device such as ROM, RAM, flash memory specially configured to store and execute program commands. Examples of the program command include a machine language code created by a complier and a high-level language code executable by a computer using an interpreter. The hardware device may be configured to be operated as at least one software module to perform an operation of the present disclosure, and vice versa. Further, an apparel production monitoring method in the above-described apparel production monitoring system and device may be implemented as a computer program or application stored in a storage medium and executed by a computer.

The above description of the present disclosure is provided for the purpose of illustration, and it would be understood by a person with ordinary skill in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A apparel production monitoring system using image recognition, comprising:
a first camera module that takes an image of apparel products; and
a monitoring device that analyzes the image of the apparel products to grasp the number and sizes of the apparel products, receives a transmission image of the apparel products, and compares and analyzes it with a previously learned transmission image to detect a defect of the apparel products.

2. The apparel production monitoring system of claim 1,
wherein the monitoring device computes pixel characteristics of a background image acquired before the first camera module takes the image of the apparel products, sets a first region of interest in the background image, sets a second region of interest in the image of the apparel products, computes a difference in pixel characteristics between an image of an apparel product in the second region of interest and a background image in the first region of interest, perform binarization to a result of the computed difference and thus recognize an object of the apparel product from the binarized image.

3. The apparel production monitoring system of claim 2,
wherein the monitoring device updates pixel characteristics of the background image based on pixel characteristics of a background included in the image of the apparel products.

4. The apparel production monitoring system of claim 1, further comprising:
a second camera module configured to take an image of the side of multiple overlapping apparel products,
wherein the monitoring device acquires a first thickness of an apparel product from a previously learned image of the apparel products, acquires a second thickness of the multiple overlapping apparel products from the image of the side of the multiple overlapping apparel products, and grasps the number of the multiple overlapping apparel products from the first thickness and the second thickness.

5. The apparel production monitoring system of claim 1,
wherein the monitoring device acquires a pattern of the apparel product from the image of the apparel products and compares and analyzes it with a previously learned pattern in an apparel material image to grasp a material of the apparel product.

6. The apparel production monitoring system of claim 1,
wherein the monitoring device extracts a contour image of the apparel product from the image of the apparel products and compares and analyzes it with a previously learned contour image for each kind of apparel product to grasp the kind of the apparel product.

7. The apparel production monitoring system of claim 1,
wherein the monitoring device detects edges from the image of the apparel product and sets the edges as feature points, acquires shapes of the feature points, and calculates a maximum vertical length and a maximum horizontal length of the apparel product from the feature points to grasp the size of the apparel product from the maximum vertical length and the maximum horizontal length.

8. The apparel production monitoring system using image recognition of claim 1,
wherein the defect of the apparel products includes a logo error, a thread, color bleeding, a needle, and a defective design pattern.

9. The apparel production monitoring system of claim 8,
wherein the monitoring device previously learns a transmission image for each defect of the apparel products and stores a learning result file for each defect of the apparel products and loads the learning result file at the time of defect inspection of the apparel products, and compares and analyzes it with the transmission image of the apparel products to grasp the kind of defect of the apparel products and the location of the defect in the apparel products.

10. An apparel production monitoring device using image recognition, comprising:
an image acquisition unit that receives an image of apparel products taken by a camera module and receives a transmission image of the apparel products;
a product count unit that counts the number of the apparel products based on the image of the apparel products;
a product sensing unit that senses information of the apparel products based on the image of the apparel products; and
a defect detection unit that detects a defect of the apparel products by comparing and analyzing the transmission image of the apparel products with a previously learned transmission image.
